(19) United States
(12) Patent Application Publication
(10) Pub. No.: US 2023/0320381 A1
(43) Pub. Date: Oct. 12, 2023

(54) PROCESS FOR PRODUCING A PROTEIN PRODUCT

(71) Applicant: Verbio Vereinigte BioEnergie AG, Leipzig (DE)

(72) Inventors: Fabian BONK, Leipzig (DE); Anton VAN PUTTEN, Bramsche (DE); Michael VAN LAER, Halle (Saale) (DE); Michael SCHLIMBACH, Halle (Saale) (DE); Oliver LÜDTKE, Markkleeberg (DE)

(21) Appl. No.: 18/132,132

(22) Filed: Apr. 7, 2023

(30) Foreign Application Priority Data
Apr. 7, 2022 (EP) 22167072.2

(51) Int. Cl. A23K 10/38

(52) U.S. Cl. CPC A23K 10/38

(57) ABSTRACT

The invention relates to a process for a protein product from thin stillage, the process comprising the steps of: producing a first mixture from i) thin stillage and ii) a first aqueous solution or a first organic solvent; separating a solid phase from the first mixture by means of a first solid-liquid separation; producing a second mixture from i) the solid phase and ii) a second aqueous solution or a second organic solvent, provided that the first mixture and/or the second mixture must contain an organic solvent; and separating a solid phase from the second mixture by means of a second solid-liquid separation, wherein the solid phase comprises or includes the protein product.

The invention relates to a process for producing a protein product.

### TECHNICAL BACKGROUND

In Germany, a reduction of CO₂ emissions from fuels is required by law, which can be achieved by admixing bioethanol, amongst others. The production of bioethanol from plant-based raw materials is known. Important raw materials for bioethanol production are cereals such as rye, corn, wheat and triticale.

For bioethanol production, the cereal is ground, mashed and fermented with the addition of yeast. The fermented mash is sent for distillation, during which the separation of the ethanol produces as a by-product what is known as the stillage (synonym: whole stillage), which is made up of organic components of the mash that have not been converted into ethanol, and also salts and yeast.

Stillage is typically used directly as a raw product, in dried form or in the following further forms as animal feed:
thin stillage (liquid phase from solid-liquid separation of stillage)
stillage solids (solids from solid-liquid separation of stillage, is also known as ‘wet cake’ or ‘wet distillers grains’)
thin stillage concentrate (evaporated thin stillage)
WDGS (‘wet distillers grains and solubles’, mixture of thin stillage concentrate and stillage solids)
DDGS (‘dried distillers grains with solubles’=dried mixture of thin stillage concentrate and stillage solids)

Of the above-mentioned feeds, thin stillage or thin stillage concentrate has the highest crude protein content. However, the crude protein content is only in the range between 20 and 45 wt. % DS, which results in a low sales value.

In order to increase the added value and enable use in the food industry, a product with the highest possible crude protein content in combination with nutritive properties is required. Thin stillage and thin stillage concentrate are particularly suitable as a starting material for producing a protein product for the food industry, as they have the highest crude protein content among the feeds. Using other by-products such as WDGS, DDGS or stillage solids as raw material increases the operational effort, as all of them have a lower crude protein content than thin stillage.

Known processes to obtain a product with a high crude protein content from thin stillage achieve higher, but not sufficiently high crude protein contents.

For example, a raw protein content of at most 30.5 wt. % DS has been achieved by filtration and spray drying of thin stillage from cereal processing (DE 20 2009 013 389 U1). A tricanter can be used to separate thin stillage into an oil fraction, an aqueous fraction and a protein-rich paste containing at most 58.6 wt. % DS crude protein (US 2014/0242251 A1).

In order to achieve higher crude protein contents, attempts have been made to bring proteins from the solid into solution. The protein-containing solution is then separated from the solid, whereupon the proteins are recovered from the solution. Known methods for bringing proteins into solution include high temperatures in combination with an alkaline aqueous process fluid (WO 2021204391 A1), a solvent selected from the group of ethanol and hexane (U.S. Pat. No. 8,454,802 B2), or one of said solvents in combination with sodium hydroxide (U.S. Pat. No. 9,487,565 B2).

For example, Chatzifragkou et al. (2016) treated whole stillage (referred to as ‘spent solids’) with 70% vol. ethanol at 50-90° C. for 30 minutes. A majority of the proteins were extracted into the ethanol-containing solution. This ethanol-containing solution was diluted with deionised water, cooled to −20° C., and the precipitated proteins separated by centrifugation, washed with deionised water and dried in a freeze dryer. The resulting solid contained a reduced crude protein content of 4.7 wt. % and the protein extract extracted through ethanol contained a crude protein content of 62.4 wt. % (Afroditi Chatzifragkou, Parvathy Chandran Prabhakumari, Ondrej Kosik, Alison Lovegrove, Peter R. Shewry, Dimitrios Charalampopoulos, Extractability and characteristics of proteins deriving from wheat DDGS, Food Chemistry, Volume 198, 2016, Pages 12-19).

The disadvantages of this method are the energy consumption to set the temperatures of 50-90° C. for the extraction of the proteins into the ethanol-containing solution, as well as the complex process steps for precipitation and separation of the proteins from the ethanol-containing solution and the associated cooling energy.

The patent application WO 2021204391 A1 is another example in which proteins are dissolved and then isolated from the solution. The independent claim of this process is shown in FIG. 1 and will be described in more detail below: thin stillage is fed to a solid-liquid separation, wherein the solid phase is reused. This solid phase is diluted with an aqueous process liquid and then tempered to at least 60° C. Subsequently, the pH value of the tempered diluted solid phase is set to alkaline. This alkaline process stream is cooled down and fed to a solid-liquid separation, whereby the liquid phase is further used. The pH value of this liquid phase is set to an acidic pH value and this acidic liquid phase is later fed to a solid-liquid separation, whereby the solid phase is further used. This solid phase is dispersed in a solvent and then fed to a solid-liquid separation, whereby the solid phase represents or contains the protein product. In this process, crude protein contents of at least 70 wt. % DS can be achieved. However, the disadvantages of this process are the costs for alkali, acid, thermal energy for tempering as well as the large number of containers and separation apparatus and hence the high investment costs in containers and apparatus.

Furthermore, the prior art from closely related fields is either not applicable or entails too many disadvantages:

For example, protein isolates from corn mash, which have crude protein contents of up to 73 wt. % DS are known (U.S. Pat. No. 4,624,805 A). The disadvantage of these products is that they are not obtained from residual materials such as thin stillage, but from the unfermented raw material corn mash and are therefore less sustainable. Also, compared to thin stillage, corn mash does not contain yeasts, which have a positive influence on the nutritive and functional properties of protein products. Another disadvantage is that corn mash consists mainly of starch compared to thin stillage. The crude protein content of corn mash is only about 8 wt. % DS and a large part of the proteins is bound between starch grains. In contrast, thin stillage has already undergone fermentation, in which most of the starch has been degraded, and distillation, which causes further breakdown of the organic polymers and structures. This results in different protein extraction requirements for corn mash compared to thin stillage.

Accordingly, there is a continuing need for efficient production processes for high-quality protein products with a high crude protein content, in which by-products of bioethanol production, such as thin stillage, are used as raw materials in the interests of sustainability.

### SUMMARY OF THE INVENTION

The present invention addresses the problem described above and solves it by providing a process for producing a protein product. The process comprises the steps of:
a) producing a first mixture from i) thin stillage and ii) a first aqueous solution or a first organic solvent;
b) separating a solid phase from the first mixture by means of a first solid-liquid separation;
c) producing a second mixture from i) the solid phase and ii) a second aqueous solution or a second organic solvent, provided that the first mixture and/or the second mixture must contain an organic solvent; and
d) separating a solid phase from the second mixture by means of a second solid-liquid separation, wherein the solid phase comprises or includes the protein product.

In step (a), an aqueous solution or an organic solvent is added to the thin stillage.

From the mixture of thin stillage and solution from step (a), a solid phase is separated in step (b) by means of solid-liquid separation.

In step (c), an aqueous solution or an organic solvent is added to the solid phase from step (b), wherein an organic solvent is used at least in step (a) or step (c).

In step (d), the mixture from (c) is separated into a further solid phase and a further liquid phase by means of solid-liquid separation.

Surprisingly, it was found that contrary to the prior art, the crude protein content of the solid phase does not decrease due to the addition of an organic solvent, but on the contrary increases significantly.

The advantages achieved with the invention compared to known processes are in particular that a significant increase in the crude protein content in the protein product is achieved in comparison to the thin stillage. Furthermore, the use of acids and alkalis is significantly reduced or even obsolete, and the number of process steps and complexity of the process is significantly reduced, as protein does not have to be brought into solution and then separated again from the solvent. The use of thermal energy, which is typically required to bring proteins into solution, is also reduced. Surprisingly, the process according to the invention has succeeded in increasing the crude protein content from thin stillage from step (a) to solid phase in step (d) with the use of an organic solvent. So far, the prior art has always described an extraction of protein in ethanol and thus a reduction of the crude protein content in the solid phase (see e.g., Chatzifragkou et al. (2016)).

Further embodiments are explained in the detailed description and the figures.

### BRIEF DESCRIPTION OF THE FIGURES

The invention is explained in more detail below by means of an embodiment example and the associated drawing compared to the prior art.

FIG. 1 describes the prior art.

FIGS. 2a and 2b describe a schematic process sequence of an embodiment of the process according to the invention.

FIG. 3 describes a schematic process sequence of a further embodiment of the process according to the invention.

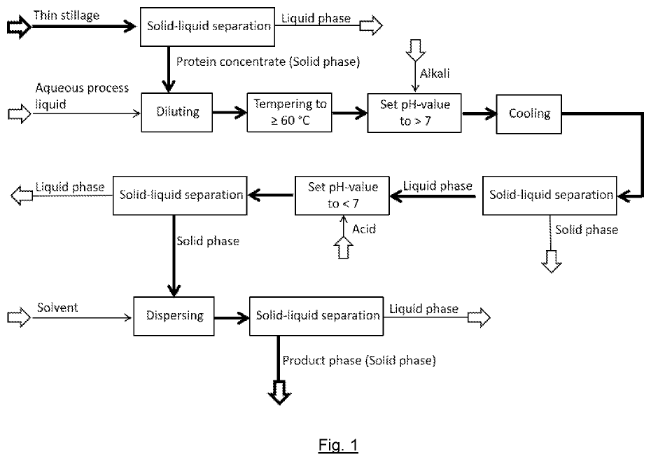

### DETAILED DESCRIPTION OF THE INVENTION

In the context of the present invention, the dry substance (DS) is understood to be the solid residue obtained after removing the solvent (e.g., water or organic solvent) from a suspension (e.g., from a stillage) or from a solution. That is to say, the solid residue is to be understood as the totality of all previously dissolved or suspended solids (e.g., crude proteins, yeast, and salts). The mass of dry substance is called dry matter.

In the context of the present invention, dry substance content (DS content) is understood to be the percentage by mass of the dry substance in relation to the total mass of the suspension (e.g., the stillage) or solution. The dry substance content is expressed in percent by weight (wt. %).

In the present invention, “crude protein content” means the proportion of crude protein in the dry substance (DS). The crude protein content (CP) of a sample is determined analytically by means of Kjeldahl nitrogen determination. Here, the analytically determined nitrogen content of the sample is multiplied by the conversion factor 6.25 to obtain the crude protein content. This is given in wt. % DS.

The increase in crude protein content refers to the relative change in crude protein content between two substances and is expressed in % rel. For example, if a protein product with a crude protein content of 35 wt. % DS is produced from a thin stillage with a crude protein content of 20 wt. % DS, the increase in crude protein content is 75% rel.

In the context of the present invention, particle size distribution is understood to be the distribution of particles by volume as determined using a Laser Scattering Particle Size Analyzer as described by Wang et al. (2009) (Wang, H., Wang, T., Pometto, A. L., III and Johnson, L. A. (2009), A Laboratory Decanting Procedure to Simulate Whole Stillage Separation in Dry-Grind Corn Ethanol Process. J Am Oil Chem Soc, 86: 1241-1250). The d50-value and the d90 value describe, as known from the prior art, statistical values that are read from the cumulative particle size distribution. They indicate the particle size in μm below which 50% (d50 value) or 90% (d90 value) of all measured particles are found in the distribution related to the volume.

In the present invention, the term “stillage” includes the residue from the distillation of a cereal mash containing ethanol. The term “whole stillage” is used synonymously for stillage.

In the context of the present invention, “solid-liquid separation” is understood to mean a process that separates a suspension into a two-phase system comprising a solid phase and a liquid phase. The solid-liquid separation can preferably take place in a separator, sedicanter or decanter. Solid-liquid separation can also be achieved by other processes such as filtration.

In a two-phase system, a solid phase is the phase that has the higher dry substance content. A solid phase can comprise a suspension or a sedimented solid (residue). In a two-phase system, a liquid phase is understood to be the phase which has the lower dry substance content. A liquid phase can comprise a suspension or a clear solution.

An aqueous solution is a solution that consists of a majority of water. Majority means more than 50 wt. %.

During the processing of manioc or grain, such as rye, wheat, corn, triticale, barley, rice and millet or combinations thereof, into bioethanol, the by-product stillage is produced after separating the ethanol from the fermented mash. The composition of the stillage is influenced by the type of grain and by the process management of the bioethanol process.

Stillage from bioethanol plants for biofuel production can be used, as well as stillage from bioethanol plants for the production of other ethanol products such as drinking alcohol or disinfectants.

A variety of other by-products can be produced from the stillage. A solid and a liquid phase are thus produced by the solid-liquid separation of the stillage. This is preferably done with a decanter or a filter press. The solid phase is known as stillage solids, ‘wet cake’ or ‘wet distillers grains’. The stillage solids can be dried to DDG. The liquid phase is known as thin stillage. Thin stillage can be evaporated to thin stillage concentrate. Optionally in this step, oil can also be separated e.g., with a tricanter. Thin stillage concentrate can be mixed with stillage solids to form WDGS. The so-called DDGS can also be produced from thin stillage concentrate together with DDG. Other combinations such as a mixture of stillage and stillage solids can also be produced as a by-product.

Among the by-products mentioned, thin stillage is particularly suitable for the production of a protein product, as it already has a high crude protein content. The dry substance content (DS content) of a thin stillage can preferably be at least 5 wt. % and at most 18 wt. %. In one embodiment of the process, the thin stillage can be evaporated to thin stillage concentrate before the aqueous solution or organic solvent is added in step (a). The DS content of the thin stillage concentrate can preferably be 21 to 33% wt. %. Thin stillage concentrate is also referred to as ‘condensed distillers solubles’ or ‘syrup’.

In a preferred embodiment, the thin stillage has a particle size distribution based on particle volume with a d50 value of at most 100 μm, preferably at most 50 μm, and a d90 value of at most 1000 μm, preferably at most 500 μm. It is known to the skilled person how the particle size distribution of material flows can be influenced.

An example of particle size distributions of thin stillage and stillage is given by Wang et al. (2009), in their study a d50 value of approx. 10-50 μm was measured for thin stillage and approx. 100-500 μm for stillage (‘industry whole stillage’), as well as a d90 value of 500-1000 μm for thin stillage and over 1000 μm for stillage.

In a preferred embodiment, the process is designed in such a way that the thin stillage has an acidic pH-value. In a particularly preferred embodiment, the process is such that the thin stillage, solid phases and mixtures in steps (a), (b) and (c) are not set to an alkaline pH. This is advantageous as it reduces costs for alkali and negative effects on protein product properties compared to the prior art.

In a preferred embodiment, the process according to the invention can be designed in such a way that the thin stillage or the thin stillage concentrate is fed to an oil separation before the addition of aqueous solution or organic solvent in step (a), and oil is separated by means of processes known in the prior art. This is advantageous as the crude protein content of the thin stillage or thin stillage concentrate is increased and oil can be obtained as a valuable product. In a further embodiment, the process according to the invention can be designed in such a way that the oil separation in step (b) and/or step (d) is carried out with the aid of a tricanter.

In a further embodiment, the process according to the invention can be designed in such a way that the thin stillage is produced from DDGS or WDGS or dried stillage resuspended in aqueous solution. This can be advantageous, for example, if the production sites of stillage and protein product are far apart.

In a preferred embodiment, the process is designed in such a way that in step (a) the amount of aqueous solution or organic solvent is selected such that a DS content of at most 19 wt. %, preferably at most 9 wt. %, particularly preferably at most 4 wt. % results in the mixture. The aqueous solution or the organic solvent in step (a) has a lower DS content than the mixture in step (a). Preferably, the aqueous solution or the organic solvent has a DS content of less than 10 wt. %.

From the mixture prepared in step (a), a solid phase is separated in step (b) by means of solid-liquid separation. This solid-liquid separation is advantageous, among other things, as it separates part of the salt content from the suspended biomass. The liquid phase can be fed to a biogas plant, for example. Preferably, the liquid phase is fed to a process water treatment. If the liquid phase contains organic solvent, it is advantageous to feed it to a recovery of the organic solvent.

In a preferred embodiment, the process water treatment is designed in such a way that a process liquid concentrate and an aqueous solution are produced, wherein the DS content of the process liquid concentrate is significantly higher than the DS content of the aqueous solution. Preferably, the process water treatment represents an evaporation or reverse osmosis. The process liquid concentrate is preferably fed to a biogas plant. The aqueous solution is preferably fed to one of the steps (a) to (c).

In a preferred embodiment, the process further comprises step (b.2): adding an aqueous solution to the solid phase from (b) and separating a further solid phase from this mixture of aqueous solution and solid phase from step (b) by means of solid-liquid separation, wherein the further solid phase is fed to step (c). This solid-liquid separation is advantageous, amongst others, because it separates part of the salt content from the suspended biomass. Preferably, the mixture of solid phase and aqueous process liquid has a DS content of at most 15% wt. %, preferably at most 11% wt. %, particularly preferably at most 8% wt. %. Preferably, the aqueous solution has a DS content of less than 0.5 wt. % and is selected from the group comprising fresh water and aqueous solutions from process water treatment, such as condensates from evaporation plants or permeates from reverse osmosis plants. Step (b.2) can be carried out several times. This is advantageous as it further reduces the salt content of the suspended biomass. The liquid phase can preferably be used in step (a). This is advantageous as it reduces the need for fresh water or treated process water in the process. The liquid phase can also be fed to a biogas plant or process water treatment, for example.

In step (c), an aqueous solution or an organic solvent is added to the solid phase from step (b), whereby an organic solvent is used in at least one of steps (a) or (c). Accordingly, if no organic solvent was added in step (a), an organic solvent must be added in step (c). If organic solvent has already been added in step (a), the addition of organic solvent in step (c) is optional.

Surprisingly, it was found that, in contrast to the prior art, the crude protein content of the solid phase does not decrease by adding an organic solvent, but on the contrary increases significantly. One possible explanation, with no claim as to completeness, is the omission of the harsh conditions used in the prior art (long retention time, high temperatures and alkaline pH), which presumably bring proteins increasingly into solution and thereby decrease the crude protein content in the solid phase that can be separated with a solid-liquid separation.

Preferably, the process is designed such that aqueous solution is used in step (a) and organic solvent is used in step (c). Hence, in embodiment example 3b), an increase in the crude protein content in the protein product of 88% rel was achieved with this variant compared to the thin stillage, whereas in embodiment example 3a), an increase in the crude protein content of 76% rel was achieved with the addition of organic solvent to step (a) and aqueous solution to step (c).

Organic solvents are, for example, those known from feed or food processing such as ethanol, isopropyl, ethyl acetate or hexane. Organic solvents do not have to be added in pure form, but merely in the form of solutions with a majority of organic solvents. Majority means more than 50 wt. %. This means that they can also include water, for example, or be added as a mixture with aqueous solutions. This has the advantage that, for example, an organic solvent obtained by distillation can be used that still contains water. Common processes for the recovery of solvents from liquid and solid phases are known to the skilled person. If ethanol is used as an organic solvent, the recovery of the solvent can be usefully combined with a bioethanol plant.

In a preferred embodiment, the process according to the invention can be designed in such a way that the organic solvent in step (a) and/or step (c) is an ethanol-containing solution which contains at least 51 wt. %, preferably at least 80 wt. %, particularly preferably at least 95 wt. % of ethanol.

In a preferred embodiment, the process according to the invention can be designed such that a temperature of 49° C., preferably 39° C., particularly preferably 29° C. is not exceeded. The low temperatures are advantageous because, among other things, the energy consumption of the process can be reduced in this way.

In a preferred embodiment, the process according to the invention can be designed in such a way that in step (c) so much organic solvent is added that a DS content of at most 15 wt. %, preferably at most 9 wt. %, particularly preferably at most 6 wt. % is achieved. In experiments, a lower DS content led to a greater increase in the crude protein content compared to the used thin stillage. For example, in embodiment 4, the dilution of the solid phase from step (b) to a DS content of 9.0 wt % was compared to the dilution to a DS content of 5.4 wt %. The stronger dilution (to a DS content of 5.4 wt. %) resulted in an increase in the crude protein content of 92% rel compared to the used thin stillage. In contrast, the weaker dilution (to a DS content of 9.0 wt. %) led to an increase in the crude protein content of 84% rel. This result is surprising, as the skilled person would have expected, based on the prior art, a reduction in the crude protein content through the use of ethanol.

In step (d), the diluted solid phase from step (c) is separated into a further solid phase and a further liquid phase by means of solid-liquid separation. The further solid phase contains a higher crude protein content than the thin stillage in step (a) and also a higher crude protein content than the solid phase in step (b).

In a preferred embodiment, steps (a) to (d) can also be carried out in a filtration apparatus without intermediate removal of the solid phase. In this case, the process is designed in such a way that the solid-liquid separation in step (b) is carried out in the filtration apparatus and the solid phase remains in the filtration apparatus. Adding aqueous solution or organic solvent to the solid phase in step (a) and step (c) is done directly in the filtration apparatus and separating the solid phase in step (d) can be done in the same apparatus.

In this preferred embodiment, the above-mentioned DS contents of the mixtures after adding aqueous solution or organic solvent are to be understood as calculated values.

For example, if 1 t of thin stillage concentrate with a DS content of 30 wt. % is added to the filtration apparatus and thereafter 1 t of fresh water with a DS content of approx. 0 wt. % is passed through the filter, the calculated result is a mixture with a DS content of 15 wt. %.

In a preferred embodiment, the process further comprises step (e): drying the solid phase from (d), wherein the drying is preferably carried out to a DS content of at least 90 wt. %.

In a preferred embodiment, the process according to the invention can be designed such that the solid-liquid separation is selected from the group consisting of decanter, sedicanter, separator and filter apparatus. In a particularly preferred embodiment, the process according to the invention can be designed in such a way that the DS content of the solid phase is set as high as possible during the solid-liquid separations in steps (b) and (d). This has the advantage that a high water content is separated from the solid phase in this way and thus more non-protein components dissolved in the water can be separated from the solid phase. The routine optimization of solid-liquid separations with regard to a high DS content in the solid phase is known to the skilled person.

In a preferred embodiment, the process according to the invention can be designed in such a way that an additional enzymatic treatment occurs in one of the steps mentioned. In a particularly preferred embodiment, for the enzymatic treatment, enzymes are preferably selected from the group consisting of peroxidases, laccases, pectinases, lipases, phytases, and oligosaccharide-degrading enzymes such as amylases, cellulases and hemicellulases. This is advantageous since it allows non-proteinaceous substances to be brought into solution and to be partially separated in a solid-liquid separation. Proteases can also be used to improve the product properties. However, this can also have the disadvantage of reducing the crude protein content in the product. The selection of suitable enzymes and their use are known to the skilled person.

In a preferred embodiment, the process according to the invention can be designed in such a way that the process causes an increase in the crude protein content from thin stillage to protein product of at least 63% rel, preferably at least 75% rel. For example, without the use of organic solvent, an increase in the crude protein content of only 58% rel to 62% rel was achieved (see embodiments 4 and 7d). With the use of organic solvent, on the other hand, an increase in the crude protein content of more than 75% rel was made possible in the embodiments.

### EMBODIMENTS

### Practical Example 1

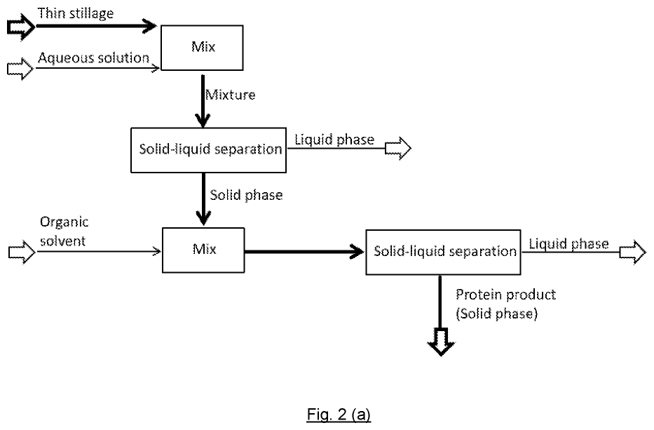

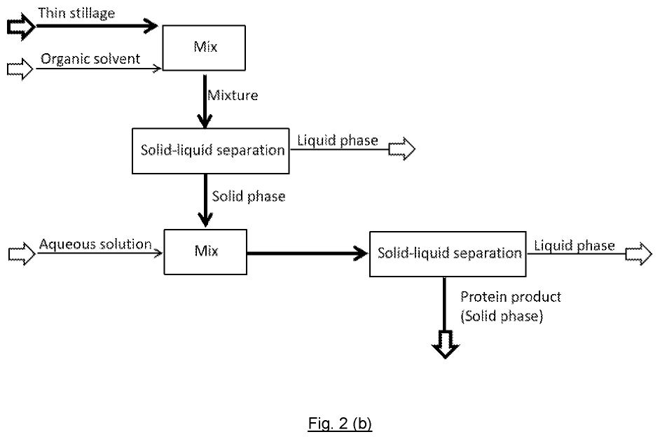

FIGS. 2 (a) and (b) show schematic representations of the process, which are explained below by way of example using the recovery of a protein product from thin stillage.

### Practical Example 1 (a)

FIG. 2 (a) shows a possible embodiment of the process.

Step (a): An aqueous solution is added to a thin stillage.

Step (b): The mixture from step (a) is fed to a decanter for solid-liquid separation and is separated into a solid phase and a liquid phase.

Step (c): An organic solvent is added to the solid phase from step (b). In this example, this is mandatory at this point as no organic solvent was added in step (a).

Step (d): The mixture from step (c) is fed to a separator for solid-liquid separation and is separated into a solid phase and a liquid phase. The solid phase is the protein product and has a higher crude protein content than the thin stillage provided in step (a).

### Practical Example 1 (b)

FIG. 2 (b) shows a possible embodiment of the process.

Step (a): An organic solvent is added to a thin stillage.

Step (b): The mixture from step (a) is fed to a decanter for solid-liquid separation and is separated into a solid phase and a liquid phase.

Step (c): An aqueous solution is added to the solid phase from step (b). The addition of an organic solvent is not mandatory at this point in this example, as organic solvent was already added in step (a).

Step (d): The mixture from step (c) is fed to a separator for solid-liquid separation and is separated into a solid phase and a liquid phase. The solid phase is the protein product and has a higher crude protein content than the thin stillage provided in step (a).

### Practical Example 2

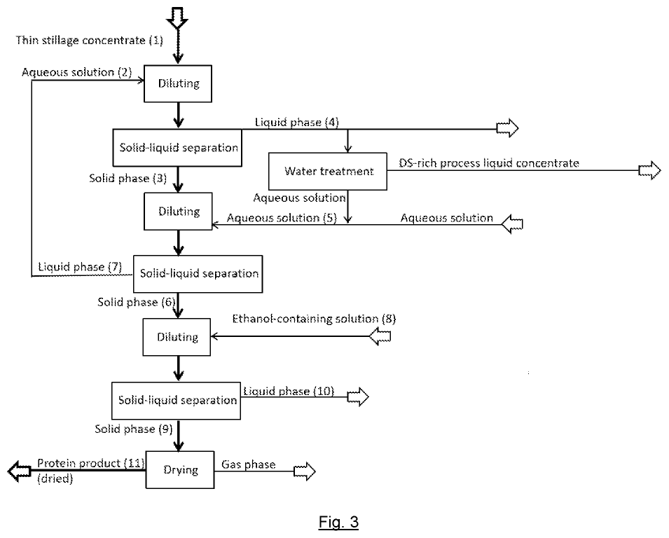

FIG. 3 shows a schematic representation of the process, which is explained below by way of example using the recovery of a protein product from thin stillage concentrate.

Step (a): 100 t/h of thin stillage concentrate (1) are diluted with aqueous solution (2) to a DS content of 19 wt. %. The aqueous solution is the liquid phase (7) from step (b.2) and has a DS content of less than 10 wt. %.

Step (b): The diluted thin stillage concentrate from step (a) is fed to a decanter for solid-liquid separation and is separated into a solid phase (3) and a liquid phase (4). The liquid phase is fed to a process water treatment, in which a DS-rich process liquid concentrate and an aqueous solution with a DS content of less than 0.5 wt. % are produced.

Step (b.2): The solid phase from step (b) is diluted with aqueous solution (5) to a DS content of 11 wt. %. This aqueous solution has a DS content of less than 0.5 wt. % and partly comes from the process water treatment in step (b). The remaining part consists of further aqueous solutions with a DS content of approx. 0 wt. % or fresh water. The diluted solid phase is fed to a separator for solid-liquid separation and is separated into a solid phase (6) and a liquid phase (7).

Step (c): The solid phase from step (b.2) is diluted with ethanol-containing solution (8) to a DS content of 8 wt. %. The mass fraction of ethanol in the ethanol-containing solution is 80 wt. %.

Step (d): The diluted solid phase from step (c) is fed to a separator for solid-liquid separation and is separated into a solid phase (9) and a liquid phase (10).

Step (e): The solid phase from step (d) is fed to a drying process, in which the DS content is increased to 90 wt. %. The dried solid phase (11) represents the protein product. The protein product has an increase in crude protein content of 89% rel compared to the provided thin stillage concentrate from step (a).

### Practical Example 3

In example 3, the steps in which the organic solvent is added are varied. In example 3a), the organic solvent is added to thin stillage. In example 3b), water is added to thin stillage and the organic solvent is added to the solid phase formed after a solid-liquid separation.

### 3a) Addition of Organic Solvent to Thin Stillage

Step 1: Thin stillage from an industrial bioethanol production with rye and triticale as main raw materials is provided.

Step 2: The thin stillage from step 1 is mixed well with pure ethanol, abbreviated as EtOH in the following. The DS content of the thin stillage diluted with EtOH is 3.3 wt. %.

Step 3: The suspension from step 2 is centrifuged at 4500 g for 15 minutes and the supernatant is decanted.

Step 4: The sediment (solid phase) from step 3 is diluted with water to a DS content of 4.7 wt. %.

Step 5: The suspension from step 4 is centrifuged at 4500 g for 15 minutes, the supernatant is decanted.

Step 6: The sediment (solid phase) from step 5 is analyzed for crude protein content. The increase in crude protein content compared to the thin stillage is 76% rel.

### 3b) Addition of Organic Solvent to Solid Phase

Step 1: Thin stillage from an industrial bioethanol production with rye and triticale as the main raw material is provided.

Step 2: The thin stillage from step 1 is mixed well with fresh water. The DS content of the diluted thin stillage is 2.7 wt. %.

Step 3: The suspension from step 2 is centrifuged at 4500 g for 15 minutes, the supernatant is decanted.

Step 4: The sediment (solid phase) from step 3 is diluted with EtOH to a DS content of 3.0 wt. %.

Step 5: The suspension from step 4 is centrifuged at 4500 g for 15 minutes, the supernatant is decanted.

Step 6: The sediment (solid phase) from step 5 is analyzed for crude protein content. The increase in crude protein content compared to the thin stillage is 88% rel.

### Practical Example 4

In embodiment 4, the addition of organic solvent is compared to the addition of water.

Step 1: Thin stillage from an industrial bioethanol production with rye as the main raw material is provided.

Step 2: In a beaker, the thin stillage is suspended with water until it is free of lumps. The DS content of the diluted thin stillage is 3.4 wt. %.

Step 3: In four balanced centrifuge beakers, each with a capacity of 700 ml, 600 g of diluted thin stillage from step 2 are added. Subsequently, they are centrifuged in a centrifuge at 4500 g for 15 minutes and then decanted. By weighing again and subtracting the empty weight of the centrifuge beaker, the weight of the solid phase is determined.

Step 4: In the centrifuge beakers from step 3, the solid phase is diluted with either water or ethanol (EtOH concentration >99%). In centrifuge beaker 1, it is diluted with water to a dry matter content of 7.7 wt. %. In centrifuge beaker 2, it is diluted with water to a dry matter content of 4.5 wt. %. In centrifuge beaker 3, it is diluted with ethanol to a dry matter content of 9.0 wt. %. In centrifuge beaker 4, it is diluted with ethanol to a dry matter content of 5.4 wt. %.

The difference in density between water and ethanol results in an equal volume in beakers 1 and 3, as well as in beakers 2 and 4. Beakers 1 and 2 do not correspond to any embodiment of the process according to the invention, since no organic solvent is added.

Step 5: The contents of the centrifuge beakers from step 4 are suspended until free of lumps.

Step 6: The centrifuge beakers from step 5 are centrifuged in a centrifuge at 4500 g for 15 minutes and then decanted. The masses of the solid phases are determined by weighing again and subtracting the empty weights.

Step 7: The solid phases from step 6 are analyzed for their crude protein content. The increase in crude protein content compared to the thin stillage is 62% rel for beaker 1, 62% rel for beaker 2, 84% rel for beaker 3, and 92% rel for beaker 4. This example shows the advantage of using the organic solvent, which leads to a significant increase in crude protein content compared to only using water.

### Practical Example 5

Step 1: Thin stillage from an industrial bioethanol production with wheat as the main raw material is provided.

Step 2: The thin stillage from step 1 is diluted with water to a dry matter content of 3 wt. % and well mixed.

Step 3: The suspension from step 2 is centrifuged at 4500 g for 15 minutes. The supernatant is decanted.

Step 4: The sediment (solid phase) from step 3 is analyzed for crude protein content. The increase in crude protein content compared to the thin stillage is 53% rel.

Step 5: The sediment (solid phase) from step 3 is diluted with EtOH to a dry matter content of 4.8% wt. %.

Step 6: The suspension from step 5 is centrifuged at 4500 g for 15 minutes and the supernatant is decanted.

Step 7: The sediment (solid phase) from step 6 is analyzed for crude protein content. The increase in crude protein content compared to the thin stillage is 75% rel.

### Practical Example 6

Step 1: Thin stillage from an industrial bioethanol production with corn as the main raw material is provided.

Step 2: The thin stillage from step 1 is diluted with water to a DS content of 2.7 wt. % and well mixed.

Step 3: The suspension from step 2 is centrifuged at 4500 g for 15 minutes. The supernatant is decanted.

Step 4: The sediment (solid phase) from step 3 is analyzed for crude protein content. The increase in crude protein content compared to the thin stillage is 73% rel.

Step 5: The sediment (solid phase) from step 3 is diluted with EtOH to a dry matter content of 4.4% wt. % and resuspended.

Step 6: The suspension from step 5 is centrifuged at 4500 g for 15 minutes, the supernatant is decanted.

Step 7: The sediment (solid phase) from step 6 is analyzed for crude protein content. The increase in crude protein content compared to the thin stillage is 108% rel.

### Practical Example 7

In the following, the use of different organic solvents is compared to the use of water.

### 7a) Ethanol as Organic Solvent

Step 1: Thin stillage from an industrial bioethanol production with triticale as the main raw material is provided.

Step 2: The thin stillage from step 1 is diluted with water to a dry matter content of 3.4 wt. % and well mixed.

Step 3: The suspension from step 2 is subjected to solid-liquid separation. The supernatant is decanted.

Step 4: The sediment (solid phase) from step 3 is analyzed for crude protein content. The increase in crude protein content compared to the thin stillage is 56% rel.

Step 5: The sediment (solid phase) from step 3 is diluted with EtOH to a DS content of 5.6 wt. % and resuspended.

Step 6: The suspension from step 5 is centrifuged at 4500 g for 15 minutes. The supernatant is decanted.

Step 7: The sediment (solid phase) from step 6 is analyzed for DS content and crude protein content. The increase in crude protein content is 75% rel compared to the thin stillage and 35% rel compared to the solid phase in step 4.

### 7b) Isopropyl as Organic Solvent

Step 1: The sediment (solid phase) from example 7a), step 3, is diluted with Isopropanol to a DS content of 3.4 wt. % and resuspended.

Step 2: The suspension from step 1 is centrifuged at 4500 g for 15 minutes. The supernatant is decanted.

Step 3: The sediment (solid phase) from step 2 is analyzed for crude protein content. The increase in crude protein content is 82% rel compared to the thin stillage and 48% rel compared to the solid phase in embodiment 7a), step 4.

### 7c) Ethyl Acetate as Organic Solvent

Step 1: The sediment (solid phase) from example 7a), step 3, is diluted with ethyl acetate to a DS content of 3.4 wt. % and resuspended.

Step 2: The suspension from step 1 is centrifuged at 4500 g for 15 minutes. The supernatant is decanted.

Step 3: The sediment (solid phase) from step 2 is analyzed for crude protein content. The increase in crude protein content compared to the thin stillage is 80% rel and 44% rel compared to the solid phase in embodiment example 7a), step 4.

7d) Example not According to the Invention with Water Instead of Organic Solvent

Step 1: The sediment (solid phase) from example 7a), step 3, is diluted with water to a DS content of 3.4 wt. % and resuspended.

Step 2: The suspension from step 1 is centrifuged at 4500 g for 15 minutes and the supernatant is decanted.

Step 3: The sediment (solid phase) from step 2 is analyzed for crude protein content. The increase in crude protein content compared to the thin stillage is 58% rel. There has been no significant increase in crude protein content compared to the solid phase in example 7a), step 4.

1. A process for producing a protein product from thin stillage, the process comprising the steps of:
a) producing a first mixture from i) thin stillage and ii) a first aqueous solution or a first organic solvent;
b) separating a solid phase from the first mixture by means of a first solid-liquid separation;
c) producing a second mixture from i) the solid phase and ii) a second aqueous solution or a second organic solvent, provided that the first mixture and/or the second mixture must contain an organic solvent; and
d) separating a solid phase from the second mixture by means of a second solid-liquid separation, wherein the solid phase comprises or includes the protein product.

2. The process according to claim 1, wherein in step (a) the amount of aqueous solution or organic solvent is selected such that a DS content of at most 19 wt. %, preferably at most 9 wt. %, particularly preferably at most 4 wt. % results in the first mixture.

3. The process according to claim 1, wherein the process further comprises step (b.2): adding an aqueous solution to the solid phase from (b), wherein the solid phase is preferably diluted to a DS content of less than 15 wt. %, preferably less than 11 wt. %, particularly preferably less than 8 wt. %, and separating a further solid phase by means of solid-liquid separation, wherein the further solid phase is fed to step (c).

4. The process according to claim 3, wherein at least part of the liquid phase from step (b.2) is fed as an aqueous solution to step (a).

5. The process according to claim 1, wherein in step (c) so much organic solvent is added that a DS content of at most 15 wt. %, preferably at most 9 wt. %, particularly preferably at most 6 wt. % results in the mixture.

6. The process according to claim 1, wherein the process further comprises step e): drying the product phase from d), preferably drying to a DS content of at least 90 wt. %.

7. The process according to claim 1, wherein the thin stillage is evaporated to thin stillage concentrate prior to the preparation of the mixture in step (a).

8. The process according to claim 7, wherein the thin stillage concentrate is fed to an oil separation prior to the production of the mixture in step (a).

9. The process according to claim 1, wherein steps (b) to (d) are carried out in a filtration apparatus.
